(19) United States
(12) Patent Application Publication
(10) Pub. No.: US 2005/0257520 A1
(43) Pub. Date: Nov. 24, 2005

(54) Operational method for a compressor

(76) Inventors: Michael Fischle, Esslingen (DE); Ulrich Springer, Stuttgart (DE); Daniel Streu, Stuttgart (DE)

Correspondence Address: WILLIAM COLLARD;COLLARD & ROE, P.C., 1077 NORTHERN BOULEVARD, ROSLYN, NY, 11576, US

(21) Appl. No.: 10/524,580

(22) PCT Filed: Jul. 26, 2003
(86) PCT No.: PCT/EP03/08278

§ 371 Date: Jul. 15, 2005

(30) Foreign Application Priority Data
Aug. 16, 2002 (DE) 10237416.3

(51) Int. Cl. F02D 23/00; F02B 33/44

(52) U.S. Cl. 60/600; 60/605.2

(57) ABSTRACT

The invention relates to a method for operating a compressor in the intake section of an internal combustion engine, in particular of a motor vehicle. A state variable which describes the behavior of the compressor, for example the frequency and/or amplitude of the intake air flow, is monitored. If the state variable exceeds or drops below at least one predefined or predefinable limiting value, intervention is carried out in a regulating and/or controlling fashion. A particularly simple way of implementing this method is obtained in that an output signal, generated for regulating and/or controlling the internal combustion engine, of an air flow sensor which is arranged in the intake tract is used as the state variable.

The present invention relates to a method for operating a compressor in the intake section of an internal combustion engine, in particular of a motor vehicle, having the features of the preamble of claim 1.

In a compressor, in particular in a compressor which operates as a turbomachine, for example exhaust gas turbocharger, the operating range which can be appropriately used is limited in the case of small mass flow rates or volume flow rates as a result of what is referred to as “compressor pumping” during which the air flow separates and flows back in the compressor. The compressor pumping entails a reduction in the charging pressure and an undesired generation of noise. The intention is to avoid compressor pumping in particular in an application of the compressor in the intake section of an internal combustion engine.

DE 100 07 669 A1 discloses an operating method of the type mentioned at the beginning in which a state variable which describes the behavior of the compressor is monitored and intervention is carried out in a regulating fashion if the state variable exceeds or drops below a predefined or predefinable limiting value. As a result of these measures the compressor can be operated in a stable operating range right next to a pumping limit. In this context the pressure or temperature either upstream or even downstream of the compressor can be determined as the state variable to be considered; alternatively, the compressor mass flow rate or compressor volume flow rate can also be considered. A suitable measuring device for monitoring the state variable is proposed for a device which can carry out the known method.

DE 36 23 696 A1 discloses a compressor with devices for preventing pumping, in which compressor measuring sensors are mounted at setpoint separation points which are of particular risk of separation of the flow and/or are shaped for that purpose. These setpoint separation points may be embodied in the form of guide vanes which are entirely or partially thicker in construction or curved or bulges in walls. As a result, when the compressor operation approaches the pumping limit, the flow boundary layer is intended to separate firstly at the setpoint separation points. This can be sensed by the measuring sensors arranged there. The corresponding regulating device can then take suitable countermeasures before the boundary layer separation occurs over the whole compressor stage. Pumping of the compressor can thus be avoided. The formation of setpoint separation points in the compressor is associated with increased expenditure which may be acceptable in a compressor of an aircraft engine but is not possible for a compressor which is arranged in the intake section of an internal combustion engine, in particular of a motor vehicle.

DE 36 05 958 A1 discloses a device for sensing and eliminating separation oscillations on compressor vanes. In order to be able to sense precisely the start of pumping of the compressor and to be able to take countermeasures in good time using simple means, a sound pressure pickup which is inserted into the feed duct and is attached to a duct wall with insulation from the body shell is used in said document for determining the operating state of the compressor which leads to the compressor pumping. This sound pressure pickup is preferably composed of a microphone which is suitable for picking up acoustic frequencies in the feed fluid in the region of approximately 0.1 Hz to 1000 Hz at sound pressure levels of 80 dB to approximately 160 dB. The sound pressure pickup or the microphone is connected to a sound discriminator which controls a rotational-speed-regulator drive motor of the compressor or a bypass valve for the mass flow rate which is fed by the compressor. Attaching the sound pressure pickups which are used at suitable locations within the compressor also requires an increased expenditure here, which is hardly significant in the case of expensive systems. The known device is therefore integrated into a compressor of a motor vehicle system. For application in a compressor which is arranged in the intake section of an internal combustion engine in order to supercharge said engine, the known device seems to be too costly.

The present invention is concerned with the problem of disclosing an improved way for avoiding compressor pumping for a compressor.

This problem is solved according to the invention by the subject matter of the independent claims. Advantageous refinements are the subject matter of the dependent claims.

The present invention is based on the general idea of monitoring the behavior of the compressor by means of an output signal of an air flow sensor which is present in any case in the intake section of the internal combustion engine and is required for the satisfactory operation of the internal combustion engine. In other words the invention intervenes in an air flow sensor which is already present, and in its output signal in order to monitor the compressor behavior. The invention makes use here of the realization that the output signal of the air flow sensor is correlated to the air mass flow rate or to the air volume flow rate in the compressor and thus forms a state variable which describes the behavior of the compressor. Since the air flow sensor, generally an air mass flow rate meter in the form of a hot film meter, is present in any case in the intake section of the internal combustion engine, hardly any additional costs are incurred when integrating the invention since all that is necessary is to tap the output signal of the air flow sensor at a suitable location. The solution according to the invention is therefore particularly economic.

It has become apparent that the output signal of the air flow sensor exhibits a characteristic oscillation behavior as soon as instabilities occur in the flow through the compressor. In one preferred embodiment, the frequency and/or amplitude of the output signal are monitored on the basis of this realization.

In one development, the intervention which is carried out when a first limiting amplitude is exceeded is different from that carried out when a second limiting amplitude which is greater than the first limiting amplitude is exceeded. This development is based on the realization that a preliminary stage of compressor pumping, specifically what is referred to as compressor creaking, can also be detected as a result of oscillations in the output signal, but the amplitude of said creaking is less than that of the oscillations which occur in the case of compressor pumping. Since compressor creaking, in contrast to compressor pumping, does not have an adverse affect, or only an insignificantly adverse affect on the charging pressure, and instead only causes an unpleasant generation of noise, other countermeasures are expedient for compressor creaking than those for compressor pumping.

In order to avoid compressor pumping or compressor creaking, the operating behavior of the compressor can expediently be stabilized by intervening in a regulating circuit of the compressor when the respective limiting value is exceeded in such a way that, for example, a setpoint charging pressure is reduced. This measure is effective by virtue of its simplicity since the regulating circuit of the compressor which is present in any case can be used without modification. Changing the setpoint value then leads automatically to a corresponding change in the controlled variables which are influenced by the regulating circuit of the compressor. For example, an exhaust gas turbocharger has, on its turbine, an adjustable turbine guide vane geometry which is adjusted by the regulating circuit as a function of the required charging pressure. The proposed influencing of the setpoint charging pressure then results automatically in suitable actuation of the turbine guide vanes by means of the regulating circuit.

Further important features and advantages of the invention emerge from the subclaims, from the drawings and from the associated description of the figures with reference to the drawings.

It goes without saying that the features which are mentioned above and which are to be explained below can be used not only in their respectively specified combination but also in other combinations or alone without departing from the scope of the present invention.

One preferred exemplary embodiment of the invention is illustrated in the drawings and is explained in more detail in the following description, in which identical setpoint symbols relate to identical or functionally identical or similar components. In the drawings, in each case in a schematic view,

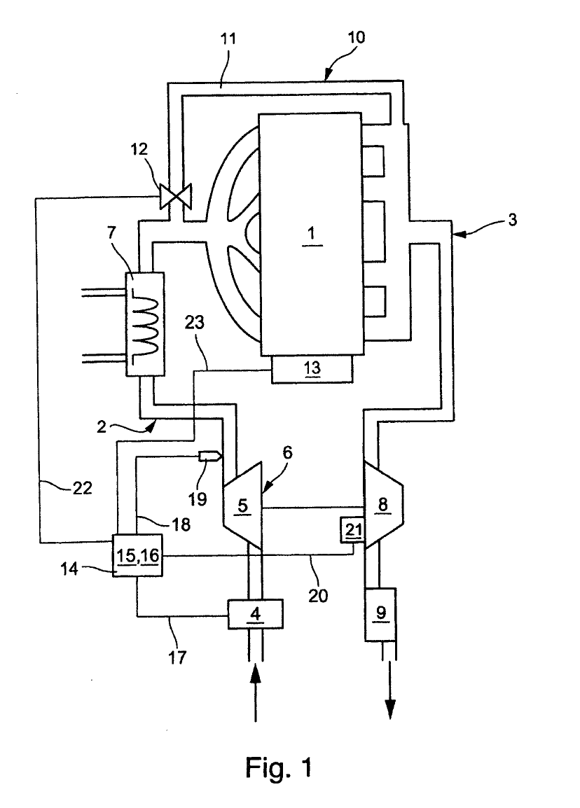

FIG. 1 shows a circuit diagram-like basic illustration of a compressor in the intake section of an internal combustion engine, and

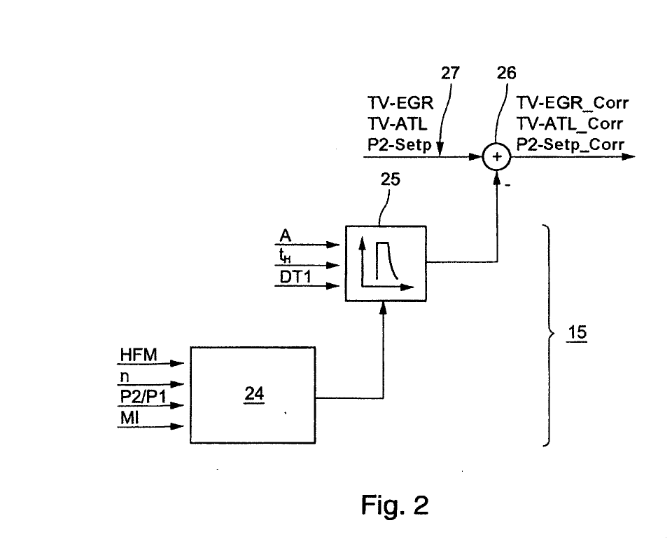

FIG. 2 shows a highly simplified block circuit diagram of a controller for influencing the behavior of the compressor.

According to FIG. 1, an internal combustion engine 1, for example a diesel engine or a petrol engine, in particular of a motor vehicle, has an intake section 2 for supplying fresh air and an exhaust gas section 3 for carrying away exhaust gas. In the intake section 2, an air flow sensor 4, a compressor 5 of an exhaust gas turbocharger 6 and a charging air cooler 7 are arranged one behind the other. A turbine 8 of the exhaust gas turbocharger 6 is arranged in the exhaust gas section 3 and has a sound damper 9 disposed downstream of it. Furthermore, the internal combustion engine 1 comprises an exhaust gas recirculation device 10 (EGR device 10) which feeds back combustion gases from the exhaust gas section 3 into the intake section 2 via an exhaust gas recirculation line 11 (EGR line 11) and leads into it downstream of the charging air cooler 7. An exhaust gas recirculation valve 12 (EGR valve 12) is arranged in the EGR line 11 in order to adjust the exhaust gas recirculation rate (EGR rate). In addition, the internal combustion engine 1 has an injection device 13 which has the purpose of adjusting the injected quantity of fuel.

A control device 14 contains a compressor control unit 15 which may include, for example, a charge air controller and/or an engine control unit 16. The compressor control unit 15 is expediently integrated by means of hardware into the engine control unit 16 which is present in any case or is implemented by means of software. Both control units 15, 16 can accordingly be accommodated in the same control device 14.

The control device 14 is connected via a first signal line 17 to the air flow sensor 4 so that the output signals which are generated by the air flow sensor 4 are made available to the control device 14. The control device 14 is connected via a second signal line 18 to a pressure sensor 19 which measures the charging pressure P2 in the intake section 2 downstream of the compressor 5. Accordingly, a signal value for the charging pressure P2 is also available to the control device 14. Via a first control line 20, the control device 14 is connected to a guide vane adjusting device 21 of the turbine 8, which can be used to adjust the guide vanes (not shown) of the turbine 8 in terms of their attitude with respect to the inflowing fluid. The control device is connected to the EGR valve 12 via a second control line 22. A third control line 23 connects the control device 14 to the injection device 13.

According to FIG. 2, the compressor control unit 15 additionally comprises an evaluation unit 24 and a correction unit 25, symbolized by a brace. At the input end the evaluation unit 24 receives various signals which are correlated to different parameters or state variables. One of the incoming signals originates from the air flow sensor 4 which is also referred to below as an HFM signal or output signal since the air flow sensor 4 is preferably what is referred to as a hot film meter which supplies an output signal (HFM signal) which correlates to the air mass flow and/or air volume flow in the intake section. This output signal of the air flow sensor 4 is fed to the control device 14 via the first signal line 17, as a result of which it is made available to the compressor unit 15 and thus to the evaluation unit 24. Further signals supplied to the evaluation unit 24 may be, for example: a rotational speed n of the internal combustion engine 1, a pressure ratio P2/P1 between the charging pressure P2 downstream of the compressor 5 and the intake pressure P1 upstream of the compressor 5 as well as an injection quantity MI with which the injection device 13 supplies the internal combustion engine 1 at a particular time. The rotational speed n is in any case available to the control device 14 or the engine control device 16, as is the injection quantity MI. The pressure ratio P2/P1 is determined using the P2 pressure sensor 19 and a P1 pressure sensor (not shown) which is connected to the intake section 2 upstream of the compressor 5. The evaluation unit 24 generates at least one outgoing signal as a function of the incoming signals, and said outgoing signal is passed on to the correction unit 25.

Correction signals which are connected into a regulating circuit 27 at a node 26 in order to regulate the compressor 5 are generated in the correction unit 25 as a function of further parameters such as, for example, the amplitude A, hold time tₕ and decay characteristics, for example in accordance with a DT1 transmission element of the respectively used regulating element. The compressor unit 15 preferably influences the setpoint charging pressure P2-setp and/or the pulse duty factor TV-ATL of the turbocharger 6 which is required to activate the guide vane adjusting device 21 and/or the pulse duty factor TV-EGR of the EGR valve 12 which is required to actuate the EGR valve 12. The logic operations on the incoming control variables with the correction variables of the correction unit 25 are carried out in the nodes 26, as a result of which corrected control values are formed: TV-EGR_Corr, TV-ATL_Corr and P2-Setp_Corr.

The respective correction variables can be calculated in the correction unit 25 as a function of parameters or determined using stored characteristic diagrams.

The compressor 5 is preferably operated according to the invention as follows:

When the internal combustion engine 1 is operating, the exhaust gas turbocharger 6 is operated as a function of the operating states of the internal combustion engine 1. The more power the internal combustion engine 1 has to output, the higher the charging pressure P2 to be set. The charging pressure P2 can be influenced, for example, using the guide vane adjusting device 21. By closing the guide vanes it is possible to increase the ram pressure upstream of the turbine 8, as a result of which its drive power increases, which leads to an increase in the charging pressure P2. When the guide vanes open, the ram pressure drops so that the decreasing turbine power reduces the charging pressure P2.

In particular at relatively low rotational speeds of the internal combustion engine 1 it is possible for the air flow in the compressor 5 to become unstable as the charging pressure P2 increases. This state is referred to as compressor creaking and is a preliminary stage of compressor pumping during which the air flow in the compressor separates and flows back.

The invention then makes use of the realization that the HFM signal, that is to say the output signal of the air flow sensor 4 correlates to the flow behavior of the air flow in the compressor 5 at least to such an extent that it can be used to detect whether or not compressor creaking and/or compressor pumping are present. While the HFM signal exhibits as it were a continuous profile when the flow through the compressor 5 is stable, an oscillating signal, which can characterized by frequency and amplitude, is produced when compressor creaking occurs. At the transition to compressor pumping, in particular the amplitude of the oscillating output signal rises significantly.

In accordance with the present invention, the compressor control unit 15 monitors the profile of the output signal of the air flow sensor 4. The output signal of the air flow sensor 4 is required in any case by the engine control unit 16 in order to operate the internal combustion engine 1 and is therefore present in the control device 14. As soon as this HFM signal or output signal exceeds a predetermined limiting amplitude and/or a predetermined limiting frequency, the compressor control unit 15 assumes that compressor pumping or compressor creaking starts. The compressor control unit 15 then expediently starts suitable countermeasures without delay.

In one expedient development, the compressor control unit 15 initiates other countermeasures in the case of compressor creaking than in the case of compressor pumping. This embodiment is based on the realization that, in contrast to compressor pumping, no or only a small drop in charging pressure occurs in the case of compressor creaking. Accordingly, in the case of compressor creaking the disruptive generation of noise can be damped selectively by means of suitable countermeasures, as far as possible without reducing the charging pressure P2. In contrast to this, by using the countermeasures carried out to avoid or reduce compressor pumping the intention is to reduce the charging pressure P2 in order to stabilize the flow.

The reduction in the charging pressure is carried out, for example, by the compressor control unit 15 intervening in the regulating circuit of the compressor 5 which is controlled by the charging pressure P2, and by reducing there the setpoint charging pressure which is to be adjusted. This setpoint correction then leads automatically to the suitable charging-pressure-reducing measures. For example, the guide vane adjusting device 21 of the turbine 8 is actuated by means of the compressor regulating circuit. When the setpoint charging pressure is reduced, the guide vane adjusting device 21 is actuated by the compressor regulating circuit in a corresponding way in order to open the guide vanes.

Alternatively or additionally the compressor control unit 15 can also actuate the guide vane adjusting device 21 directly in order to open the guide vanes of the turbine 8. The guide vane adjusting device 21 is usually actuated using a pulse-width-modulated signal. The pulse duty factor of this signal may be between 0% and 100% or be varied in some other percentage interval, the interval limits setting the extreme positions (open to a maximum or closed to a maximum) of the guide vanes. In order to reduce the charging pressure P2 it is thus possible to change the pulse duty factor of the guide vane adjusting device 21 in such a way that the ram pressure upstream of the turbine 8 is reduced, with the result that the compressor power, and thus the achievable charging pressure P2, also decrease through the reduced turbine power.

Additionally or alternatively the compressor control unit 15 can actuate the EGR valve 12 in order to open it to lower the charging pressure P2 by correspondingly varying the corresponding pulse duty factor. As a result of the increasing degree of opening of the EGR valve 12 it is possible for more exhaust gas to pass from the exhaust gas section 3 upstream of the turbine 8 into the intake section 2, as a result of which the ram pressure upstream of the turbine 8 drops. As a consequence, the turbine power, the compressor power and the charging pressure P2 drop.

A further measure which can additionally or alternatively be carried out by the compressor control unit 15 is to actuate the injection device 13 in order to reduce the injection quantity MI. As a result of a reduced injection quantity, the pressure in the exhaust gas and thus the ram pressure upstream of the turbine 8 are reduced, which in turn leads to a reduction in the charging pressure P2.

The aforesaid countermeasures are expediently effective for a relatively short time in order to keep the reaction on the operation of the internal combustion engine 1 as small as possible.

Although the illustrated exemplary embodiment shows the compressor 5 as components of an exhaust gas turbocharger 3, the present invention is not restricted to such a compressor but rather can also be used in other compressors in which pumping or creaking may occur.

1-9. (canceled)

10. A method for operating a compressor (5) in the intake section (2) of an internal combustion engine (1), in particular of a motor vehicle, in which a state variable which describes the behavior of the compressor (5), specifically an output signal of an air flow sensor (4) which is arranged in the intake section (2) is monitored and intervention is carried out in a regulating and/or controlling fashion if this state variable exceeds or drops below at least one predefined or predefinable limiting value, wherein
the air flow sensor (4) generates the output signal for regulating and/or controlling the internal combustion engine (1) and is arranged upstream of the compressor (5) in the intake section (2),
the frequency and/or the amplitude of the output signal are/is monitored.

11. The method as claimed in claim 10, comprising when a first limiting amplitude is exceeded, intervention is carried out differently than when a second limiting amplitude which is greater than the first limiting amplitude is exceeded.

12. The method as claimed in claim 10, wherein, when the limiting value is exceeded, intervention in a regulating circuit of the compressor (5) is carried out in such a way that a setpoint charging pressure is reduced.

13. The method as claimed in claim 10, wherein, when the limiting value is exceeded, an exhaust gas recirculation valve (12) of an exhaust gas recirculation device (10) of the internal combustion engine (1) is actuated in order to open it.

14. The method as claimed in claim 13, wherein the compressor (5) forms a component of an exhaust gas turbocharger (6).

15. The method as claimed in claim 10, wherein the compressor (5) forms a component of an exhaust gas turbocharger (6), and in that when the limiting value is exceeded, a guide of a device (21) of a turbine (8) of the exhaust gas turbocharger (6) is actuated in order to open the guide vanes.

16. The method as claimed in claim 10, wherein when the limiting value is exceeded, the injection quantity of the internal combustion engine (1) is reduced.

17. An internal combustion engine, in particular of a motor vehicle,
having an intake section (2) in which a compressor (5) for generating charging air and an air flow sensor (4) for determining an output signal which correlates to the intake air flow are arranged,
having an engine control unit (16) which communicates with the air flow sensor (4) and uses the output signal to control and/or regulate the internal combustion engine (1),
having a compressor unit (15) which regulates and/or controls the compressor (5) as a function of a state variable which describes the behavior of the compressor (5),
wherein
the air flow sensor (4) is arranged upstream of the compressor (5) in the intake section (2),
the compressor control unit (15) communicates with the air flow sensor (4) and uses the frequency and/or the amplitude of the output signal of the air flow sensor (4) to control and/or regulate the compressor (5).
